(19) United States
(12) Patent Application Publication
(10) Pub. No.: US 2023/0169506 A1
(43) Pub. Date: Jun. 1, 2023

(54) STORE SYSTEM, INFORMATION PROCESSING APPARATUS, AND INFORMATION PROCESSING METHOD

(71) Applicant: NEC Corporation, Minato-ku, Tokyo (JP)

(72) Inventors: Yuji TAHARA, Tokyo (JP); Shinya YAMASAKI, Tokyo (JP); Motoyuki NAKAMURA, Tokyo (JP); Yuuki GINOZA, Tokyo (JP)

(73) Assignee: NEC Corporation, Minato-ku, Tokyo (JP)

(21) Appl. No.: 17/922,641

(22) PCT Filed: May 6, 2021
(86) PCT No.: PCT/JP2021/017345

§ 371 Date: Nov. 1, 2022

(30) Foreign Application Priority Data
May 12, 2020 (JP) 2020-083888

(51) Int. Cl. G06Q 20/40; G06Q 20/38; G06T 7/20

(52) U.S. Cl. CPC G06Q 20/4014; G06Q 20/389; G06T 7/20

(57) ABSTRACT

A first server (100) includes: a store-entry management unit (102) that, when acquiring first individual determination information about a customer who enters a store, generates second individual determination information for a second system separated from a first system for managing customer information, and stores the acquired first individual determination information and the generated second individual determination information in association with each other in a storage unit; a transmission unit (104) that transmits the second individual determination information to the second system; an acquisition unit (106) that acquires, from the second system, the second individual determination information and purchase product information being information about a product to be purchased by the customer; and an output unit (108) that determines the first individual determination information associated with the acquired second individual determination information, and outputs the first individual determination information and the purchase product information to a payment unit.

### TECHNICAL FIELD

The present invention relates to a store system, an information processing apparatus, an information processing method, and a program.

### BACKGROUND ART

In recent years, practical implementation of an unattended store without a cash register has been advancing due to a progress of an image recognition technique and spread of cashless settlement. Patent Document 1 describes a technique for automatically determining a person who visits a store at a store. Further, Patent Document 2 describes an information processing system for performing customer management by using face authentication. In the system in Patent Document 2, the face authentication is performed by verifying face information about a person who visits a store with registration information, and settlement processing is performed by using membership registration information.

Patent Document 3 describes a system for recording and managing a product purchased by a customer. The system in Patent Document 3 is configured in such a way as to enable recording and referring of a purchased product, and also protect personal information (for 5 example, “when, where, and what a specific individual has purchased”).

Patent Document 4 describes a system for tracking a purchase of a customer at an unattended automatic check-out store. In the system in Patent Document 4, a customer is identified by using authentication information such as an ID, biometrics information, and the like, a purchase product detected that a product has been taken out from a tray by the customer is determined and automatically associated with a cart, and accounting processing can be performed. Patent Document 4 also describes that sales performance of a product on a special tray can be collected by setting a tray on which a product is placed as a dedicated tray for a product of a specific product supply source, and can also be used for marketing.

### RELATED DOCUMENTS

### Patent Documents

Patent Document 1: International Patent Publication No. WO2019/181364
Patent Document 2: Japanese Patent Application Publication No. 2016-126749
Patent Document 3: Japanese Patent Application Publication No. 2019-20767
Patent Document 4: Japanese Patent Application Publication (Translation of PCT Application) No. 2017-521780

### SUMMARY OF INVENTION

### Technical Problem

In this way, it is required in a store operation that information about behavior of a customer in a store is collected, a need of the customer is analyzed, and the collected information is used for marketing. Meanwhile, personal information about the customer needs to be protected.

The present invention has been made in view of the circumstance described above, and an object thereof is to provide a technique for easily performing a customer analysis in a state where personal information about a customer is concealed at a store.

### Solution to Problem

In each aspect according to the present invention, each configuration below is adopted in order to solve the above-mentioned problem.

A first aspect relates to an information processing apparatus.

The information processing apparatus according to the first aspect, including:

a store-entry management unit that, when acquiring first individual determination information about a customer who enters a store, generates second individual determination information for a second system separated from a first system for managing customer information, and stores the acquired first individual determination information and the generated second individual determination information in association with each other in a storage unit;

a transmission unit that transmits the second individual determination information to the second system;

an acquisition unit that acquires, from the second system, the second individual determination information and purchase product information being information about a product to be purchased by the customer; and

an output unit that determines the first individual determination information associated with the acquired second individual determination information, and outputs the first individual determination information and the purchase product information to a payment unit.

A second aspect relates to an information processing method of an information processing apparatus executed by at least one computer.

The information processing method according to the second aspect, including,

by the information processing apparatus:

when acquiring first individual determination information about a customer who enters a store, generating second individual determination information for a second system separated from a first system for managing customer information, and storing the acquired first individual determination information and the generated second individual determination information in association with each other in a storage unit;

transmitting the second individual determination information to the second system;

acquiring, from the second system, the second individual determination information and purchase product information being information about a product to be purchased by the customer; and

determining the first individual determination information associated with the acquired second individual determination information, and outputting the first individual determination information and the purchase product information to a payment unit.

A third aspect relates to a store system.

The store system according to the third aspect, including:

a first apparatus that manages personal information; and

a second apparatus that associates a customer and a product in a store with each other, wherein

the first apparatus includes
a store-entry management unit that, when acquiring first individual determination information about a customer who enters a store, generates second individual determination information for the second apparatus, and stores the acquired first individual determination information and the generated second individual determination information in association with each other in a storage unit,
a transmission unit that transmits the second individual determination information to the second apparatus,
an acquisition unit that acquires, from the second apparatus, the second individual determination information and purchase product information being information about a product to be purchased by the customer, and
an output unit that determines, by referring to the storage unit, the first individual determination information associated with the acquired second individual determination information, and outputs the first individual determination information and the purchase product information to a payment unit, and

the second apparatus associates the second individual determination information and the purchase product information with each other by processing an image in which the store is captured.

Note that, another aspect according to the present invention may be a program causing at least one computer to execute the method in the second aspect, or may be a computer-readable storage medium that stores such a program. The storage medium includes a non-transitory tangible medium.

The computer program includes a computer program code causing a computer to execute the information processing method on the information processing apparatus when the computer program code is executed by the computer.

Note that, any combination of the components above and expression of the present invention being converted among a method, an apparatus, a system, a storage medium, a computer program, and the like are also effective as a manner of the present invention.

Further, various components according to the present invention do not necessarily need to be an individually independent presence, and a plurality of components may be formed as one member, one component may be formed of a plurality of members, a certain component may be a part of another component, a part of a certain component and a part of another component may overlap each other, and the like.

Further, a plurality of procedures are described in an order in the method and the computer program according to the present invention, but the described order does not limit an order in which the plurality of procedures are executed. Thus, when the method and the computer program according to the present invention are executed, an order of the plurality of procedures can be changed within an extent that there is no harm.

Furthermore, a plurality of procedures of the method and the computer program according to the present invention are not limited to being executed at individually different timings. Thus, another procedure may occur during execution of a certain procedure, an execution timing of a certain procedure and an execution timing of another procedure may partially or entirely overlap each other, and the like.

### Advantageous Effects of Invention

According to each of the aspects described above, a technique for easily performing a customer analysis in a state where personal information about a customer is concealed at a store can be provided.

### BRIEF DESCRIPTION OF THE DRAWINGS

FIG. 1 is a diagram illustrating a configuration example of a store system according to an example embodiment of the present invention.

FIG. 2 is a diagram for describing a configuration example of a store.

FIG. 3 is a block diagram illustrating a hardware configuration of a computer that achieves an information processing apparatus (first server) according to the example embodiment.

FIG. 4 is a functional block diagram logically illustrating a configuration of the information processing apparatus (first server) according to the present example embodiment.

FIG. 5 is a diagram illustrating one example of a data structure of user information.

FIG. 6 is a diagram illustrating one example of a data structure of store-entry management information.

FIG. 7 is a flowchart illustrating an operation example of the information processing apparatus (first server) according to the present example embodiment.

FIG. 8 is a diagram illustrating a configuration example of the store system according to the present example embodiment.

FIG. 9 is a functional block diagram logically illustrating a configuration of the information processing apparatus (first server) according to the present example embodiment.

FIG. 10 is a flowchart illustrating an operation example of the store system according to the present example embodiment.

FIG. 11 is a diagram illustrating one example of a data structure of purchase information.

FIG. 12 is a diagram illustrating an example of a data structure of a store-specific product master.

FIG. 13 is a flowchart illustrating an operation example of the store system according to the present example embodiment.

FIG. 14 is a diagram illustrating an example of a data structure of the store-entry management information.

FIG. 15 is a diagram illustrating an example of a data structure of the user information.

FIG. 16 is a flowchart illustrating an operation example of the store system according to the present example embodiment.

FIG. 17 is a diagram illustrating a configuration example of the store system according to the present example embodiment.

FIG. 18 is a functional block diagram logically illustrating a configuration example of the store system according to the present example embodiment.

FIG. 19 is a diagram illustrating one example of a data structure of cart information and customer information.

### EXAMPLE EMBODIMENT

Hereinafter, example embodiments of the present invention will be described with reference to the drawings. Note that, in all of the drawings, a similar component has a similar reference sign, and description thereof will be appropriately not included. Further, in each of the drawings, a configuration of a portion unrelated to essence of the present invention is not included and not illustrated.

“Acquisition” in an example embodiment includes at least one of acquisition (active acquisition), by its own apparatus, of data or information being stored in another apparatus or a storage medium, and inputting (passive acquisition) of data or information output from another apparatus to its own apparatus. Examples of the active acquisition include reception of a reply by making a request or an inquiry to another apparatus, reading by accessing another apparatus or a storage medium, and the like. Further, examples of the passive acquisition include reception of information to be distributed (transmitted, push-notified, or the like), and the like. Furthermore, “acquisition” may include acquisition by selection from among pieces of received data or pieces of received information, or reception by selecting distributed data or distributed information.

### First Example Embodiment

### <System Outline>

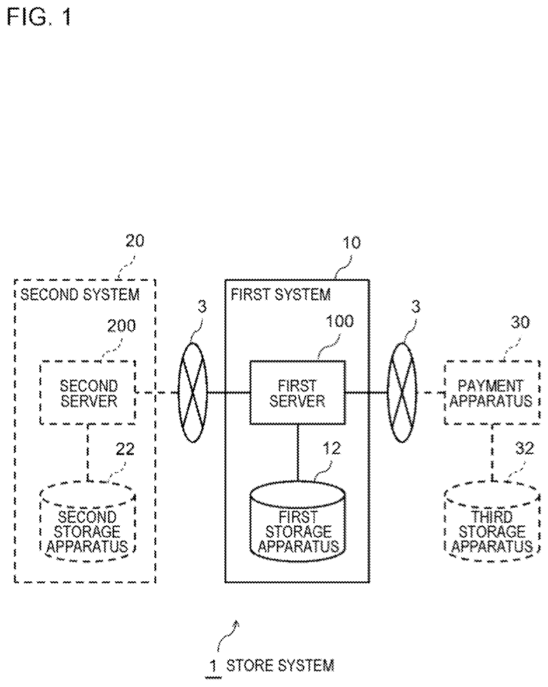

FIG. 1 is a diagram illustrating a configuration example of a store system 1 according to an example embodiment of the present invention. The store system 1 is a system for managing an unattended store without a cash register. In a first example embodiment, an example in which the store system 1 includes a first system 10 for managing customer information will be described. In a fifth example embodiment described below, an example in which a store system 1 includes a first system 10, and a second system 20 for managing purchase behavior of a customer at a store.

Further, in the present example embodiment, a configuration example in which the first system 10 does not include a payment apparatus 30 will be described. A configuration example in which the first system 10 includes the payment apparatus 30 will be described in an example embodiment described below.

The first system 10 and the second system 20 may be systems managed by different companies, organizations, and the like, or may be systems managed by the same company, organization, and the like. In the present example embodiment, the first system 10 and the second system 20 will be described as systems managed by different companies, organizations, and the like.

The first system 10 includes a first server 100 (information processing apparatus) and a first storage apparatus 12. The second system 20 includes a second server 200 and a second storage apparatus 22. The payment apparatus 30 is connected to a third storage apparatus 32. The first server 100 of the first system 10 is connected to each of the second server 200 of the second system 20 and the payment apparatus 30 via a communication network 3.

The first storage apparatus 12 stores various pieces of data and/or various programs of the first server 100. The second storage apparatus 22 stores various pieces of data and/or various programs of the second server 200. The third storage apparatus 32 stores various pieces of data and/or various programs of the payment apparatus 30.

The first storage apparatus 12 may be provided inside the first server 100, or may be provided outside. In other words, the first storage apparatus 12 may be hardware integral with the first server 100, or may be hardware separated from the first server 100. The first server 100 and the first storage apparatus 12 may be connected by the communication network 3.

The same also applies to the second storage apparatus 22 and the second server 200, and the third storage apparatus 32 and the payment apparatus 30. In other words, the second storage apparatus 22 may be provided inside the second server 200, or may be provided outside. The second storage apparatus 22 may be hardware integral with the second server 200, or may be hardware separated from the second server 200. The second server 200 and the second storage apparatus 22 may be connected by the communication network 3.

Furthermore, the third storage apparatus 32 may be provided inside the payment apparatus 30, or may be provided outside. The third storage apparatus 32 may be hardware integral with the payment apparatus 30, or may be hardware separated from the payment apparatus 30. The payment apparatus 30 and the third storage apparatus 32 may be connected by the communication network 3.

For example, the first system 10 is a system for managing personal information about a customer U who does shopping by using a store, generating payment information about a product purchased by the customer U at the store, and causing the payment apparatus 30 to perform payment processing. In the present example embodiment, the payment apparatus 30 is described as a system separated from the first system 10, but may be included in the first system 10 as described above.

The second system 20 is a system for collecting and analyzing information such as purchase behavior of the customer U (person who uses the store) at a store in a state where personal information about the customer U who does shopping by using the store is concealed, for example. The second system 20 may acquire and manage attribute information such as gender, age, a residential place, presence or absence of a spouse, a family structure, an occupation type, a hobby, and a preference, for example, as long as information that cannot determine an individual of the customer U.

As described above, in the present example embodiment, since the first system 10 and the second system 20 are systems managed by different companies or organizations, information such as purchase behavior of a person (customer U) can be collected and analyzed by tracking the behavior of the person (customer U) in a store in a state where the customer U is not determined and a state where personal information about the customer U managed by the first system 10 is concealed from the second system 20.

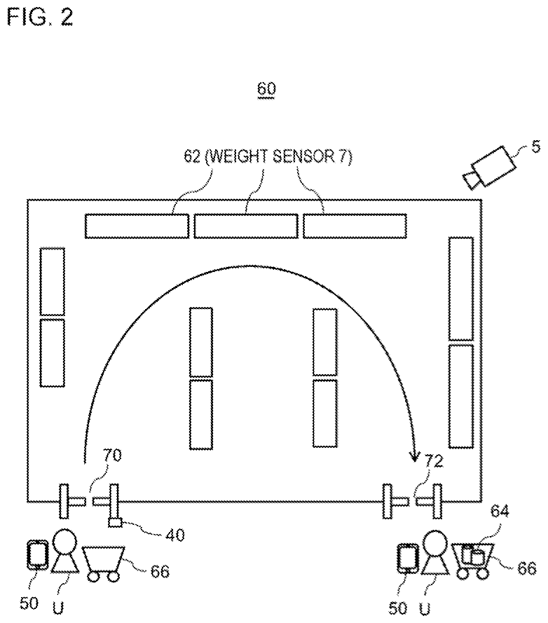

FIG. 2 is a diagram for describing a configuration example of a store 60. At least one display shelf 62 is installed at the store 60. The display shelf 62 herein is a fixture, a cold-storage or freezing showcase, a gondola, and the like including at least one shelf board or bottom surface on which a product 64 is placed. A plurality of the products 64 are displayed on the display shelf 62. The customer U enters the store 60 with a cart 66. However, the customer U may not have the cart 66. The product 64 to be a purchase target may be put in a container (such as a bag, a handbag, a sack, and a purse) possessed by the customer U himself/herself.

For example, a weight sensor 7 is provided on a shelf board or a case bottom surface of the display shelf 62. When the product 64 is taken out from the display shelf 62, a weight change is detected by the weight sensor 7, and taking out of the product 64 is detected.

A store-entry gate 70 and a store-exit gate 72 are provided at the store 60. A store-entry terminal 40 is provided at the store-entry gate 70, and the customer U performs authentication processing for a store entry in the store-entry terminal 40, and then enters the store 60. Then, the customer U puts the product 64 desired to be purchased in the cart 66, and exits from the exit gate 72 of the store 60.

A camera 5 is provided at the store 60, and generates an image in which the customer U moving in the store 60 is captured. FIG. 2 illustrates only one camera 5, but a plurality of the cameras 5 may be provided. An image generated by the camera 5 is at least any one of a moving image, a still image, and a frame image for each predetermined interval.

The camera 5 further generates an image in which the product 64 taken out from the display shelf 62 and put in the cart 66 by the customer U is captured. In the second system 20, by processing an image generated by the camera 5, a flow line of a person (customer U) in the store 60 can be tracked, and the product 64 taken out from the display shelf 62 and put in the cart 66 can be recognized.

### Hardware Configuration Example

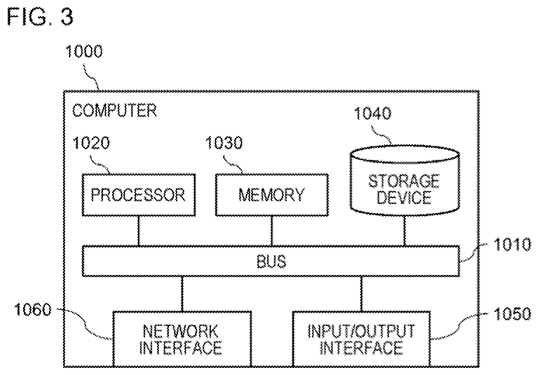

FIG. 3 is a block diagram illustrating a hardware configuration of a computer 1000 that achieves the first server 100. Each of the second server 200, the payment apparatus 30, the store-entry terminal 40, and a user terminal 50 is also achieved by a similar computer 1000.

The computer 1000 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (for example, a store-entry management unit 102, a transmission unit 104, an acquisition unit 106, an output unit 108, and the like described below) of the first server 100 (information processing apparatus). The processor 1020 reads each program module onto the memory 1030 and executes the program module, and each function associated with the program module is achieved. Further, the storage device 1040 may also store various pieces of data and various programs of the first storage apparatus 12 of the first server 100, for example.

The program module may be stored in a storage medium. The storage medium that stores the program module may include a non-transitory tangible medium usable by the computer 1000, and a program code readable by the computer 1000 (the processor 1020) may be embedded in the medium.

The input/output interface 1050 is an interface for connecting the computer 1000 and various types of input/output equipment. The input/output interface 1050 also functions as a communication interface that performs short-range wireless communication, such as Bluetooth (registered trademark) and Near Field Communication (NFC).

The network interface 1060 is an interface for connecting the computer 1000 to a communication network. The communication network is, for example, a local area network (LAN) and a wide area network (WAN). A method of connection to the communication network by the network interface 1060 may be wireless connection or wired connection.

Then, the computer 1000 is connected to necessary equipment (for example, the store-entry terminal 40, the camera 5, the weight sensor 7, and the like) via the input/output interface 1050 or the network interface 1060.

The camera 5 includes a lens and a capturing element such as a charge coupled device (CCD) image sensor. The camera 5 further includes the computer 1000, and communicates with the first server 100 or the second server 200 via the communication network 3.

The weight sensor 7 is, for example, a piezoelectric element provided on a shelf board or a case bottom surface of the display shelf 62. A weight of the product 64 displayed on the display shelf 62 of the store 60 is detected. In the present example embodiment, taken out of the product 64 from the display shelf 62 can be detected by detecting a weight change in the product 64 displayed on the display shelf 62.

The store-entry terminal 40 includes the computer 1000, and a display, a code reader, an IC card reader, a camera, a speaker, and a microphone that are not illustrated, for example. A screen displaying a message for prompting the customer U to perform authentication processing needed for a store entry and the like may be displayed on the display.

The user terminal 50 is, for example, a portable terminal such as a smartphone and a tablet terminal. The user terminal 50 includes the computer 1000, and a display, a camera, a speaker, a microphone, an IC card, and a wireless communication unit that are not illustrated, for example.

### Functional Configuration Example

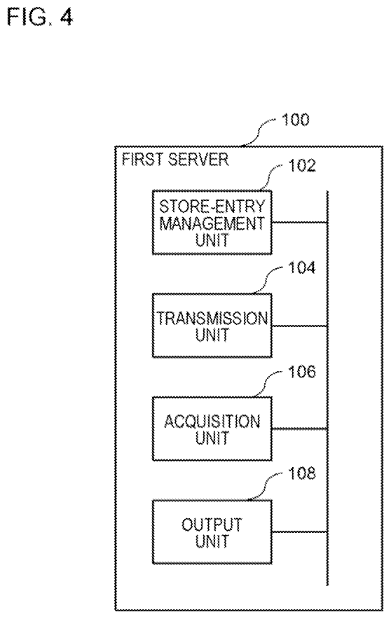

FIG. 4 is a functional block diagram logically illustrating a configuration of the first sever 100 (information processing apparatus) according to the present example embodiment. The first server 100 includes the store-entry management unit 102, the transmission unit 104, the acquisition unit 106, and the output unit 108.

Each component of the first server 100 (information processing apparatus) according to the present example embodiment in FIG. 4 is achieved by any combination of hardware of the computer 1000 in FIG. 3 and software. Then, various modification examples of an achievement method and an apparatus thereof are understood by a person skilled in the art. A functional block diagram illustrating the first server 100 according to each example embodiment illustrates a block of logical functional units instead of a configuration of hardware units.

When the store-entry management unit 102 acquires first individual determination information about the customer U who enters the store 60, the store-entry management unit 102 generates second individual determination information for the second system 20 separated from the first system 10. Then, the store-entry management unit 102 stores the acquired first individual determination information and the generated second individual determination information in association with each other in the first storage unit 12.

The first individual determination information is information that can uniquely determine the customer U in the first system 10, and is, for example, a user ID described below. Further, for example, the store 60 may be a part of a facility in a company or a school. In this case, the first individual determination information may be information including an employee number, a student number, or at least a part of these numbers that are uniquely assigned to an employee of the company or a student of the school and can uniquely determine the customer U.

As described above, the store-entry management unit 102 acquires the first individual determination information acquired by the store-entry terminal 40. In the example in FIG. 2, the store-entry terminal 40 is installed before a store entry of the store-entry gate 70 of the store 60. However, the store-entry terminal 40 may be installed at a place right after a store entry of the store 60. Furthermore, the store-entry terminal 40 may be installed in a position in the middle of a path from after the customer U passes the store-entry gate 70 of the store 60 to before the customer U enters a region where the display shelf 62 is installed. The store-entry management unit 102 acquires a user ID of the customer U read by the store-entry terminal 40 at least before the customer U enters the store 60 or an installation region of the display shelf 62.

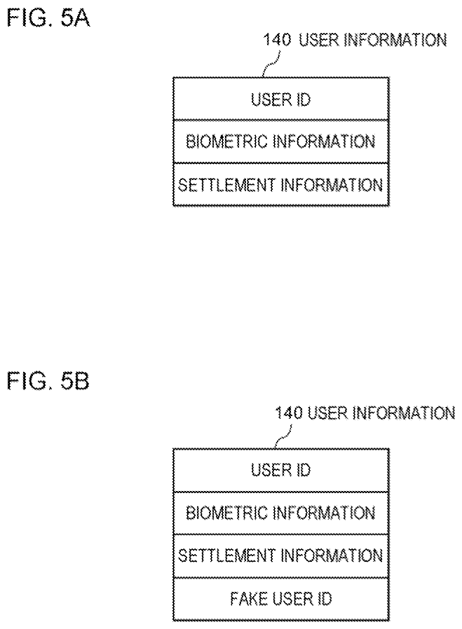

The customer U who uses the store 60 registers user information 140 in advance. Identification information (hereinafter referred to as a user ID) that uniquely determines the customer U is assigned to each customer U. As illustrated in FIG. 5(a), the user information 140 in which biometric information used for authenticating the customer U and settlement information including information such as a card number used for settlement of shopping are associated with a user ID is stored in the first storage apparatus 12. The user information 140 is not limited to this, and may include, as customer information, information such as a name, an address, a phone number of a contact address, and an e-mail address, for example.

The store-entry terminal 40 recognizes a store visit of the customer U by reading the user ID of the customer U who visits the store. Hereinafter, in the present example embodiment, the first individual determination information is described as the user ID of the customer U.

Various methods for acquiring a user ID by the store-entry terminal 40 are conceivable and exemplified below, which are not limited thereto.

(a1) A two-dimensional code such as a QR code (registered trademark) and a bar code indicating the user ID is displayed on the user terminal 50 of the customer U. The customer U holds up the two-dimensional code displayed on the user terminal 50 over the code reader of the store-entry terminal 40. The store-entry terminal 40 reads the displayed two-dimensional code by using the code reader, and acquires the user ID. For example, the two-dimensional code can be displayed on a screen by activating a predetermined application in the user terminal 50. Alternatively, the two-dimensional code may be displayed on the screen by activating a predetermined browser and logging in to a member Web page in the user terminal 50.
(a2) The user ID is recorded in an IC memory of the user terminal 50 of the customer U. The customer U brings the user terminal 50 into contact with the store-entry terminal 40. The store-entry terminal 40 reads the user ID from the IC memory of the user terminal 50 of the customer U by using the IC card reader.
(a3) The user ID is recorded in a member magnetic card being distributed to the customer U in advance. The customer U puts the magnetic card through the card reader of the store-entry terminal 40. The store-entry terminal 40 reads the user ID from the magnetic card of the customer U by using the card reader.
(a4) For the user ID, a two-dimensional code indicating the user ID is described on a surface of a membership card being distributed to the customer U in advance and formed of paper, plastic, or the like. The customer U holds up the two-dimensional code of the membership card over the code reader of the store-entry terminal 40. The store-entry terminal 40 reads the two-dimensional code from the membership card of the customer U by using the code reader, and acquires the user ID.

Furthermore, the store-entry terminal 40 performs authentication processing on a face of the customer U by verifying a feature value of a face extracted from an image generated by capturing the face by using the camera with a feature value of the face of the customer U being associated with the acquired user ID and registered in advance.

The camera that captures the face of the customer U may be provided on a front panel (not illustrated) of the store-entry terminal 40, or the like, or may be the camera 5 provided on a ceiling of the store 60, or the like. However, the authentication processing is not limited to processing using a feature value of a face, and may be authentication processing using other biometric authentication information. The other biometric authentication information includes at least any one feature value such as an iris, a vein, an auricle, a fingerprint, a voiceprint, a gait, and a stature (such as a height, a shoulder width, a body length, and a bone structure), for example. Alternatively, at least two pieces of the biometric authentication information may be combined.

The second individual determination information is used in the second system 20 as information for uniquely determining a person (customer U) who uses a store. The second individual determination information is fake (dummy) identification information that plays a role instead of the first individual determination information for concealing the first individual determination information, and is different from the first individual determination information. The store-entry management unit 102 generates the second individual determination information (hereinafter also referred to a fake user ID) that is separated from the user ID acquired by the store-entry terminal 40, and is used in the second system 20 instead of the user ID.

The transmission unit 104 transmits the fake user ID to the second server 200.

Herein, a timing for associating the user ID and the fake user ID with each other may be every time when the customer U enters the store 60, or may be before a store entry, for example, when the user information is registered or when the customer U has entered the store before.

Further, processing procedures of the store-entry management unit 102 and the transmission unit 104 are different as exemplified below depending on a timing for associating the user ID and the fake user ID with each other.

(b1) When the store-entry management unit 102 acquires the user ID of the customer U who enters a store, the store-entry management unit 102 generates the fake user ID different from the user ID, and stores the generated fake user ID in association with the user ID of the user information 140. The transmission unit 104 transmits the generated fake user ID to the second server 200.
(b2) The fake user ID generated in advance in association with the user ID is described in the user information 140. When the store-entry management unit 102 acquires the user ID of the customer U who enters a store, the store-entry management unit 102 refers to the user information 140, and reads the fake user ID associated with the acquired user ID. The transmission unit 104 transmits the read fake user ID to the second server 200.

In the method of (b1), even when the same customer U visits a store, a different fake user ID is assigned every time, and thus information as one user cannot be continuously collected. However, there are advantages of being able to manage information and simplify information processing. Further, since it is harder to estimate the customer U individual than (b2), personal information can be more firmly protected.

In the method of (b2), since the fake user ID associated with the user ID of the customer U is fixed, information as the same person can be collected in the second system 20 even when a certain customer U visits a store at different dates and time.

As illustrated in FIG. 5(b), the store-entry management unit 102 stores the fake user ID in association with the user ID of the user information 140 illustrated in FIG. 5(a).

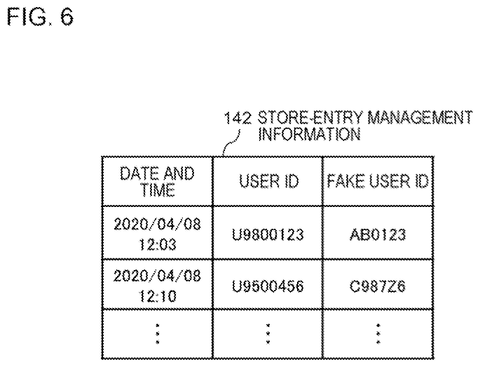

Furthermore, as illustrated in FIG. 6, the store-entry management unit 102 may store, as store-entry management information 142, date and time information indicating a date and time at 5 which the customer U enters a store, the user ID acquired by the store-entry terminal 40, and the generated fake user ID in association with one another. The second individual determination information (fake user ID) may be any information. In the example in FIG. 6, information formed of letters and numbers in a predetermined number of digits, which is not limited thereto. In the present example embodiment, description is given below on an assumption that the store-entry management unit 102 generates the fake user ID every time for each store visit of the customer U in (b1) described above, and records the fake user ID in the store-entry management information 142.

The acquisition unit 106 acquires, from the second sever 200, the second individual determination information and purchase product information being information about a product to be purchased by a person (customer U) associated with the second individual determination information. In the second system 20, person feature information that is related to behavior of a person (customer U) at the store 60 and indicates a feature of the person and product purchase information are collected and analyzed. The first system 10 acquires the purchase product information collected by the second system 20.

The person feature information is, for example, information indicating “behavior” of a person such as behavior related to a purchase, and a feature (or a pattern) such as a movement path, a gesture, and action. However, the person feature information does not include information that can determine an individual.

In the second system 20, the product 64 put in the cart 66 by the store 60 is determined based on the weight sensor 7 provided on the display shelf 62 and an image generated by the camera 5, and, for example, a product code and quantity thereof are associated with the fake user ID assigned to the person (customer U) and are passed to the first system 10.

In other words, the acquisition unit 106, from the second server 200 of the second system 20 via the communication network 3, receives a product code and quantity of the product 64 associated with the fake user ID.

The output unit 108 refers to the store-entry management information 142 of the first storage apparatus 12, and determines the user ID associated with the acquired fake user ID. Then, the output unit 108 outputs the user ID and the purchase product information to the payment apparatus 30. In other words, the output unit 108, to the payment apparatus 30 via the communication network 3, transmits the product code and the quantity of the purchase product 64 in association with the user ID.

### Operation Example

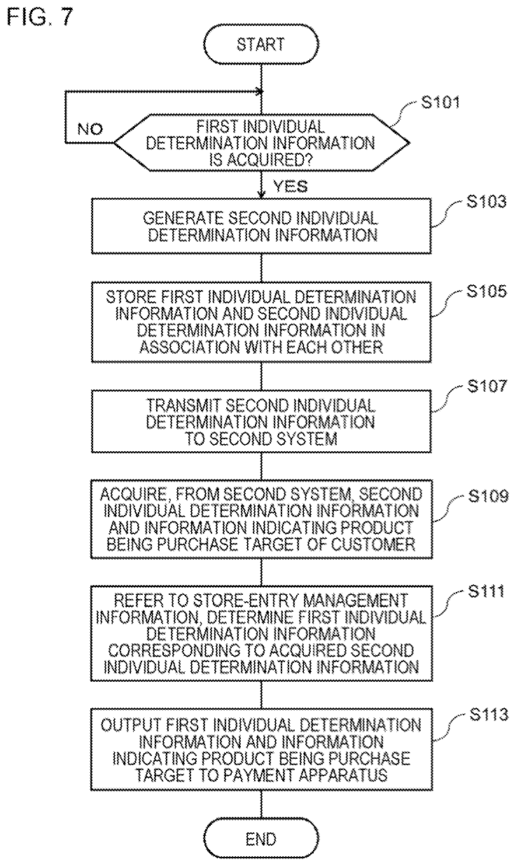

FIG. 7 is a flowchart illustrating an operation example of the first server 100 according to the present example embodiment.

First, when the customer U visits the store 60, the customer U displays a two-dimensional code for a store entry on the user terminal 50, and holds up the two-dimensional code over the code reader of the store-entry terminal 40. Then, the store-entry terminal 40 reads the two-dimensional code by using the code reader, and acquires a user ID (first individual determination information).

When the store-entry terminal 40 acquires the user ID (first individual determination information) (YES in step S101), the store-entry management unit 102 generates a fake user ID (second individual determination information) different from the user ID (step S103). The store-entry management unit 102 stores, in the first storage unit 12, the acquired user ID (first individual determination information) and the generated fake user ID (second individual determination information) in association with each other (step S105). The transmission unit 104 transmits the fake user ID (second individual determination information) to the second server 20 (step S107).

Step S101 to step S107 are processing while the customer U does shopping at the store 60 since the customer U visits the store. Subsequently, when the customer U finishes shopping and exits from the store-exit gate 72 of the store 60, the acquisition unit 106 then acquires, from the second system 20, the fake user ID (second individual determination information) and purchase product information about the person (customer U) associated with the fake user ID (step S109).

As described above, the acquisition unit 106 may passively receive information sent from the second system 20, may request and actively receive information from the second system 20 at a predetermined timing, or may combine both of the passive reception and the active reception.

A timing for acquiring the purchase product information of the person (customer U) is exemplified below, which is not limited thereto. Further, a plurality of timings may be combined.

(c1) When an exit of the person (customer U) from the store-exit gate 72 of the store 60 is detected
(c2) After a predetermined period of time has elapsed since a store entry is detected
(c3) Regularly (for example, a fixed time after closing time, a fixed time every day, a fixed time every week, a fixed time every month, and a settlement deadline)
(c4) Every time the person (customer U) puts the product 64 in and takes the product out from the cart 66

Various methods for detecting an exit of the person (customer U) from the store-exit gate 72 of the store 60 in (c1) described above are conceivable and exemplified below, which are not limited thereto. Further, a plurality of methods may be combined.

(d1) An exit from the store-exit gate 72 is detected by movement tracking in the store 60 by an image generated by the camera 5.
(d2) A store exit is detected by providing a store-exit operation terminal (not illustrated) at the store-exit gate 72, causing the customer U to operate on the operation terminal by a method similar to a store entry by using the user terminal 50 of the customer U, and acquiring the user ID of the customer U.

Then, the output unit 108 refers to the first storage apparatus 12, and determines the user ID (first individual determination information) associated with the acquired fake user ID (second individual determination information) (step S111), and outputs the user ID (first individual determination information) and the purchase product information to the payment apparatus 30 (step S113).

Various timings for outputting information from the output unit 108 to the payment apparatus 30 are conceivable and exemplified below, which are not limited thereto. A plurality of timings below may be combined within a consistent range.

(e1) Each time information is received by the acquisition unit 106
(e2) After a predetermined period of time has elapsed since information is received by the acquisition unit 106
(e3) Regularly (for example, a fixed time after closing time, a fixed time every day, a fixed time every week, a fixed time every month, and a settlement deadline) after a date and time at which information is received by the acquisition unit 106

As described above, according to the present example embodiment, when the store-entry management unit 102 acquires the user ID of the customer U who enters the store 60, the store-entry management unit 102 generates the fake user ID different from the user ID, and passes the fake user ID to the second system 20 for tracking the customer U. Meanwhile, the second system 20 manages the person (customer U) who enters the store by the fake user ID and collects person feature information, and also passes purchase product information about the person (customer U) to the first system 10. Then, processing related to settlement, that is, processing needed to be performed by determining an individual of the customer U is performed by the first system 10. Thus, the first system 10 can reliably perform the processing related to settlement for a product purchase of the customer U in a state where the customer U individual is determined, and the second system 20 can be prevented from determining the customer U individual. By managing the customer U by the fake user ID in the second system 20, person feature information about behavior of the person (customer U) at the store 60 can be collected in a state where personal information is not determined.

The second system 20 can collect the purchase product information about the person (customer U) who enters the store and the person feature information about the person (customer U) at the store 60 by using the camera 5 and the weight sensor 7 without determining the customer U individual.

### Second Example Embodiment

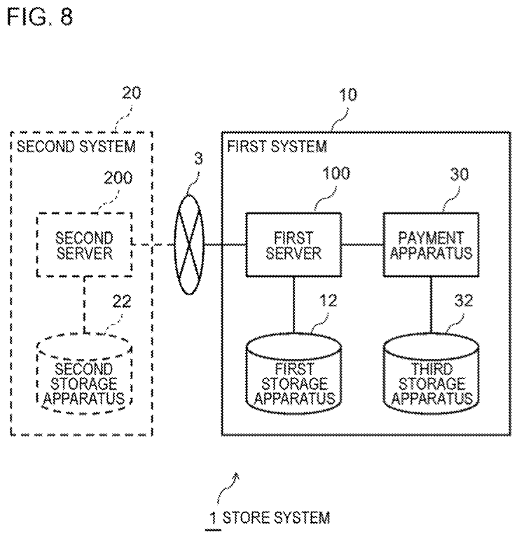

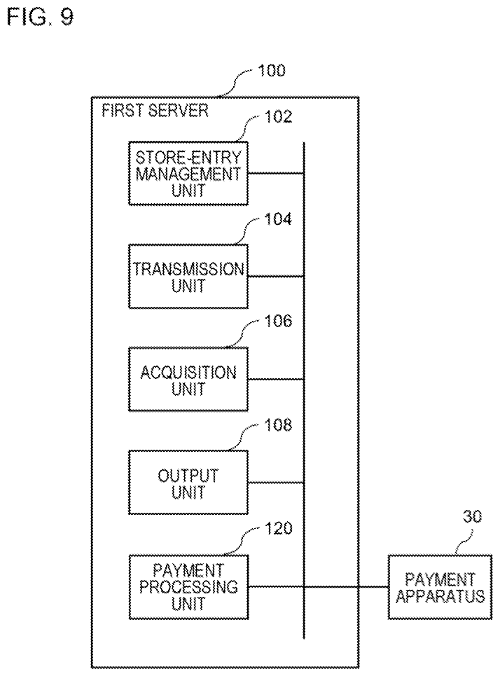

FIG. 8 is a diagram illustrating a configuration example of a store system 1 according to the present example embodiment. FIG. 9 is a functional block diagram logically illustrating a configuration of a first sever 100 (information processing apparatus) according to the present example embodiment. The store system 1 according to the present example embodiment is similar to that in the example embodiment described above except for a point that a first system 10 includes a payment apparatus 30.

### Functional Configuration Example

The first server 100 further includes a payment processing unit 120 in addition to the first server 100 in FIG. 4. At least one of the payment apparatus 30 and a third storage apparatus 32 may be provided inside the first server 100, or may be provided outside. In other words, at least one of the payment apparatus 30 and the third storage apparatus 32 may be hardware integral with the first server 100, or may be hardware separated from the first server 100. The first server 100 and at least one of the payment apparatus 30 and the third storage apparatus 32 may be connected by a communication network 3.

The payment processing unit 120 performs settlement related to a product 64 being a purchase target by using a settlement means associated with a user ID (first individual determination information). The settlement means is a credit card payment, an account transfer, a transfer from a convenience store, and the like, and is specified in advance by a customer U. The settlement means can include information such as a type, a card number, an expiration date, a name, and a security code of a credit card, or information such as a bank name, a branch name, an account type, an account number, and a name of a bank transfer account. The specified settlement means is stored in association with the user ID in user information 140 described above. Furthermore, deduction of a salary may be the settlement means in a case of a store 60 in a company.

### Operation Example

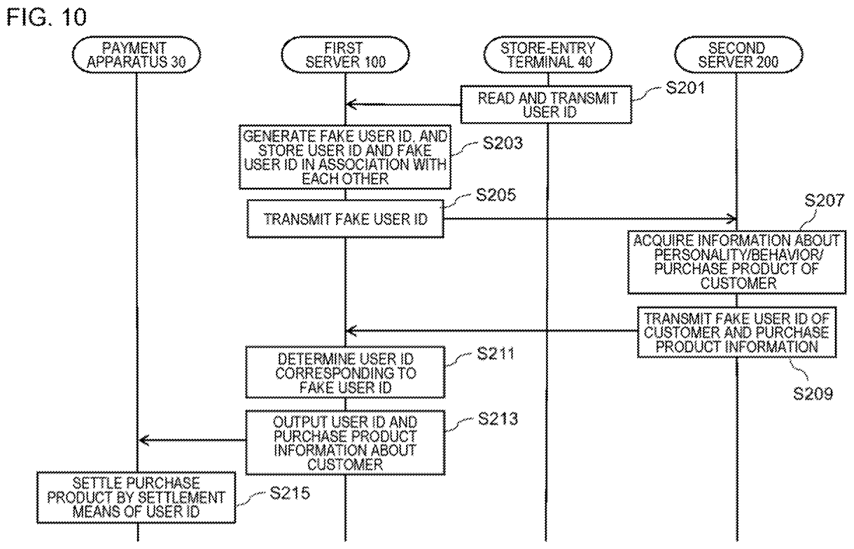

FIG. 10 is a flowchart illustrating an operation example of the store system 1 according to the present example embodiment.

First, a store-entry terminal 40 reads a two-dimensional code displayed on a user terminal 50 provided by the customer U, acquires a user ID, and transmits the user ID to the first server 100 (step S201). Then, in the first server 100, a store-entry management unit 102 generates a fake user ID associated with the user ID received from the store-entry terminal 40, and stores, as store-entry management information 142, the user ID and the fake user ID in association with each other in a first storage apparatus 12 (step S203).

Then, a transmission unit 104 transmits the generated fake user ID to a second server 200 (step S205). The second server 200 detects a store entry of a person (customer U), and acquires person feature information and purchase product information about the person (customer U) in the store 60 (step S207). A specific example of the processing of the second server 200 will be described in detail in the fifth example embodiment described below.

Then, in the first server 100, an acquisition unit 106 receives the fake user ID of the person (customer U) and the purchase product information (a product code and quantity) being transmitted from the second server 200 (step S209). An output unit 108 refers to the store-entry management information 142, and determines the user ID associated with the received fake user ID (step S211).

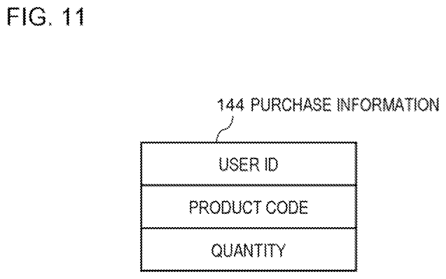

The output unit 108 may store, in purchase information 144 in FIG. 11, the purchase product information (the product code and the quantity) in association with the determined user ID. In the purchase information 144, at least one set of a product code and quantity are associated with a user ID.

Then, the output unit 108 passes, to the payment processing unit 120, the user ID and the purchase product information about the customer U being received in step S209 (step S213). The purchase product information about the customer U includes the product code and the quantity.

The payment processing unit 120 causes the payment apparatus 30 to perform settlement related to the product 64 being a purchase target of the customer U by using a settlement means associated with the user ID by referring to the user information 140 (step S215). At this time, the payment processing unit 120 transmits, to the payment apparatus 30, information in which the purchase product information (including the product code and the quantity) about the customer U and the settlement means of the customer U are associated with the user ID of the customer U.

The settlement means of the customer U is configured in such a way as to be managed in the first server 100 in the present example embodiment. However, the settlement means of the customer U may be configured in such a way as to be managed on the payment apparatus 30 side. In other words, the payment apparatus 30 may include the function of the payment processing unit 120. In this case, the user information 140 in FIGS. 5(a) and 5(b) includes only a user ID and biometric information. On the other hand, the payment processing unit 120 may store, in the third storage apparatus 32, the settlement means of the customer U in association with the user ID of the customer U as user information (not illustrated) that can be referred.

According to the present example embodiment, since the first system 10 includes the payment apparatus 30, the first system 10 can perform settlement processing of the customer U, and can also conceal information that can determine an individual of the customer U from a second system 20 separated from the first system 10. In the second system 20, tracking information about a person (customer U) at the store 60 can be collected similarly to the example embodiment described above.

### Third Example Embodiment

The present example embodiment is similar to the first or second example embodiment described above except for a point that a second system 20 is provided for each store 60 and the present example embodiment has a configuration for managing purchase product information about a customer U for each store 60. Herein, a configuration in combination with the second example embodiment will be described. Further, the configuration according to the present example embodiment can be combined with any other example embodiment within a consistent range. Hereinafter, description is given by using the functional block diagram in FIG. 9 according to the second example embodiment.

### Functional Configuration Example

The second system 20 is provided for each store 60.

A store-entry management unit 102 acquires a user ID (first individual determination information) together with store determination information, and stores the acquired store determination information further in association with a fake user ID (second individual determination information).

An output unit 108 further transmits the store determination information to a payment apparatus 30.

The store-entry management unit 102 acquires identification information that can determine the store 60, such as a store ID, together with the user ID from a store-entry terminal 40. In other words, the store-entry terminal 40 transmits, to a first server 100, the store ID of the store 60 in association with the user ID acquired from a user terminal 50 of the customer U.

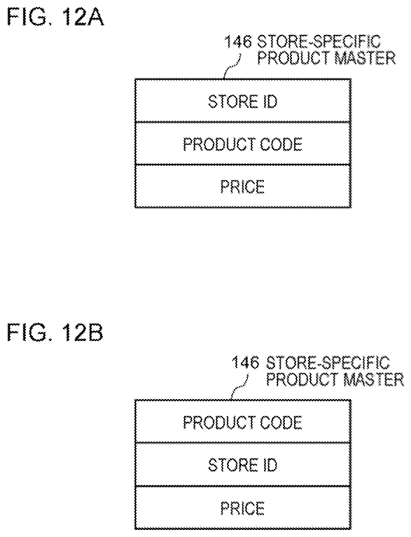

The payment apparatus 30 stores a store-specific product master 146 in a third storage apparatus 32. FIG. 12 is a diagram illustrating an example of a data structure of the store-specific product master 146. The store-specific product master 146 may be a table of a product code and a price for each store 60 as in FIG. 12(a), or may be a table of a store ID and a price for each product 64 as in FIG. 12(b).

The store-specific product master 146 stores at least a product code of the product 64 in association with a price of the product 64 by store 60. The store-specific product master 146 may further associate information such as a product name of the product 64 and a sale period and a sale price for each store 60.

### Operation Example

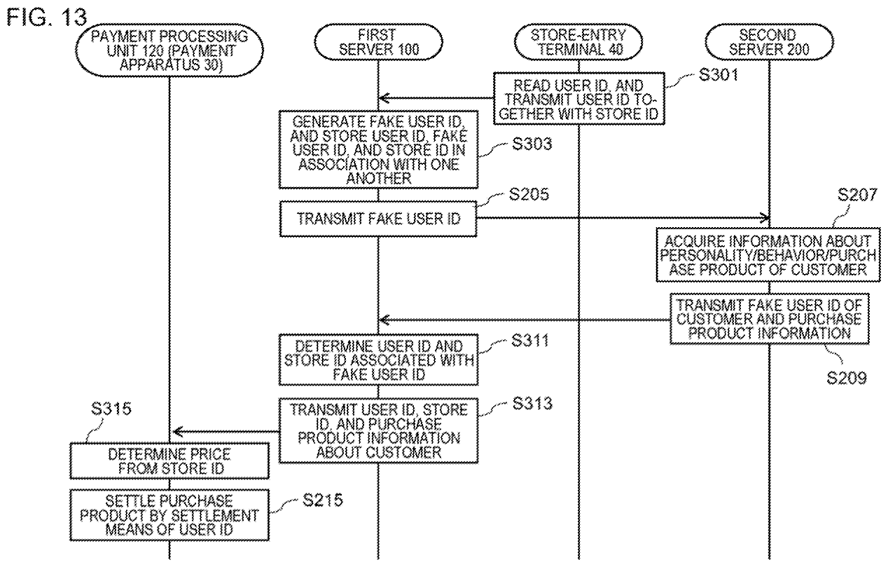

FIG. 13 is a flowchart illustrating an operation example of a store system 1 according to the present example embodiment.

The flow in FIG. 13 includes the same step S205 to step S209 and step S215 as those in the flow in FIG. 10 according to the second example embodiment, and also further includes step S301, step S303, step S311, step S313, and step S315.

First, the store-entry terminal 40 reads a two-dimensional code displayed on the user terminal 50 provided by the customer U, acquires a user ID, and further transmits the user ID together with a store ID (store determination information) of the store 60 to the first server 100 (step S301). The store-entry terminal 40 stores the store ID in advance in the memory 1030 or 5 the storage device 1040. Then, in the first server 100, the store-entry management unit 102 generates a fake user ID associated with the user ID received from the store-entry terminal 40, and stores, as store-entry management information 142, the user ID, the fake user ID, and the store ID in association with one another in a first storage apparatus 12 (step S303). Steps S205 to S209 are similar to those in FIG. 10.

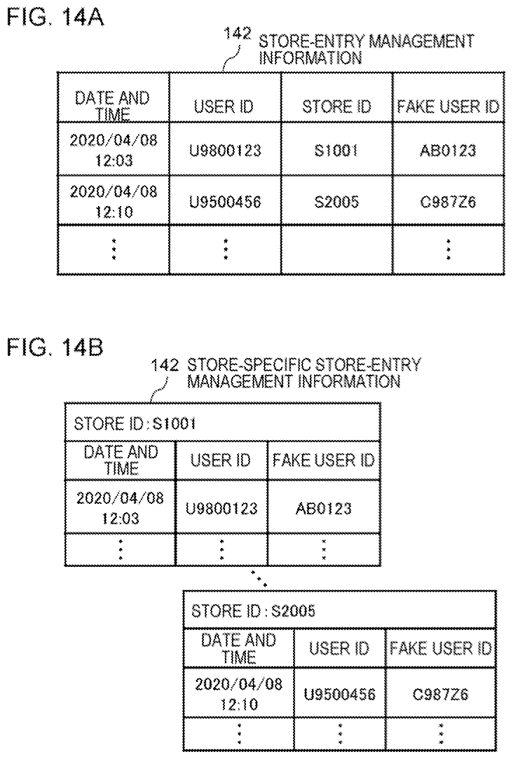

FIG. 14 is a diagram illustrating an example of a data structure of the store-entry management information 142 according to the present example embodiment. In the example in FIG. 14(a), each time the customer U enters a store, a date and time of the store entry, a store ID (store determination information) of the store 60 being entered, a user ID of the customer U, and a fake user ID different from the user ID are stored in association with one another in the store-entry management information 142. In the example in FIG. 14(b), the store-entry management information 142 in which a store ID is associated by store is stored.

Returning to FIG. 13, the output unit 108 refers to the store-entry management information 142, and determines the user ID and the store ID associated with the received fake user ID (step S311).

The output unit 108 may store, in the purchase information 144 in FIG. 11, the purchase product information (the product code and the quantity) in association with the determined user ID. In the purchase information 144, at least one set of a product code and quantity are associated with a user ID.

Then, the output unit 108 passes, to the payment processing unit 120, the user ID and the store ID that are determined in step S311 and the purchase product information (the product code and the quantity) about the customer U being received in step S209 (step S313). The payment processing unit 120 refers to the store-specific product master 146, and determines a price of the product 64 associated with the store ID (step S315).

Then, the payment processing unit 120 causes the payment apparatus 30 to perform settlement related to the product 64 being a purchase target of the customer U by using a settlement means associated with the user ID by referring to the user information 140 (step S215).

According to the present example embodiment, even when a different price setting is performed on a product for each store 60, determination information about the store 60 used by the customer U may only be transmitted in association with payment information. With a simple configuration, settlement processing can be performed at a price being set for each store 60. Furthermore, the present example embodiment can also achieve an effect similar to that in the first example embodiment.

### Fourth Example Embodiment

The present example embodiment is similar to the configuration of any of the example embodiments described above except for a point that the present example embodiment has a configuration that can change a processing level needed for tracking a person (customer U) at a store 60. A configuration in combination with the second example embodiment will be described. Further, the configuration according to the present example embodiment can be combined with any other example embodiment within a consistent range. Hereinafter, description is given by using the functional block diagram in FIG. 9 according to the second example embodiment.

### Functional Configuration Example

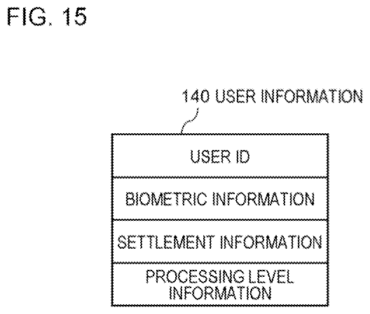

A user ID (first individual determination information) is associated with processing level information indicating a processing level needed for tracking the individual. As illustrated in FIG. 15, in the present example embodiment, processing level information is further associated with a user ID in addition to the example in FIG. 5(a) in user information 140.

A transmission unit 104 further transmits processing level information in association with a user ID to a second server 200 of a second system 20.

The second system 20 changes a processing level of tracking of a person (customer U) according to a processing level indicated by the processing level information about the person (customer U) being received from a first system 10. Tracking of the person (customer U) includes tracking and recording of the person (customer U) by using an image of the person (customer U) moving in the store 60 being generated by a camera 5.

The processing level of tracking includes, for example, strictness and the like of tracking being changed according to the person (customer U). There are a plurality of purposes for tracking the person (customer U). For example, collection of a behavior history of the person (customer U), data collection of a track of the person (customer U) for a flow line analysis in the store 60 (floor), detection of a suspicious person (such as shoplifting, robbery, and an argument), and the like are conceivable. However, the present example embodiment is not limited to these.

Then, tracking of the person (customer U) is performed by performing analysis processing on an image generated by the camera 5. For example, a resolution of an image when the image analysis processing is performed, a frame number within a predetermined period of time, and the like are changed according to the processing level. For example, the processing level is increased when a person (customer U) having a history of behavior that has made the person considered to be a suspicious person at a place behind something, such as a display shelf 62, or a person (customer U) included on a so-called blacklist and the like enters a store. Note that, a face image or a feature value of the person (customer U) may be stored on the blacklist, and whether the person is a person included on the blacklist may be able to be determined by verifying a face image in face authentication processing at a time of a store entry. For example, since it is considered to be a high possibility that the person (customer U) performs shoplifting and the like, a resolution of an image may be increased, a hand of the person (customer U) and a product 64 may be zoomed (enlarged), or a frame number within a predetermined period of time may be increased when a region in the store 60 where shoplifting and the like being specified in advance are more likely to occur is captured.

On the other hand, for example, when a person (customer U) is a regular customer, the processing level may be set low. For example, a resolution of an image may be reduced, capturing may be performed at unity magnification, or a frame number within a predetermined period of time may be reduced. When a person (customer U) is ordinary, the processing level may be set normal. In this way, the processing level may be set in three stages such as high, normal, and low, which are not limited thereto.

Further, due to a habit of action of an individual such as a way of taking out the product 64 and a way of putting the product 64 in a cart 66 by the person (customer U), accuracy of a result of detection of the product 64 by a weight sensor 7 and the analysis processing of an image generated by the camera 5 may decrease. In other words, instead of whether a person is a suspicious person, whether a person is a regular customer, or the like, the processing level may be set for each person (customer U) according to a history of accuracy (such as an error rate) of a result of the image analysis processing.

Further, whether a person (customer U) coincides with a specific behavior pattern may be verified based on a behavior history of the person (customer U), and, when coinciding with the specific behavior pattern, the processing level may be set high or the processing level may be set low. Furthermore, whether not coinciding with the specific behavior pattern, the processing level may be set high or the processing level may be set low.

By transmitting a history of accuracy (such as an error rate) of a result of the image analysis processing described above and a behavior pattern analysis result in association with a fake user ID from the second server 200 to a first server 100, the first server 100 can receive the transmitted information as information about a user ID associated with the fake user ID, and can set the processing level.

Furthermore, the processing level may be manually set by an administrator of the first server 100. For example, a result of the verification processing with a specific behavior pattern may be displayed on a display of a terminal apparatus (not illustrated) used by an administrator of the first server 100, and the processing level set by the administrator may be received. Alternatively, the processing level may be automatically set based on a verification result (degree of coincidence) or an image analysis processing result (error history).

### Operation Example

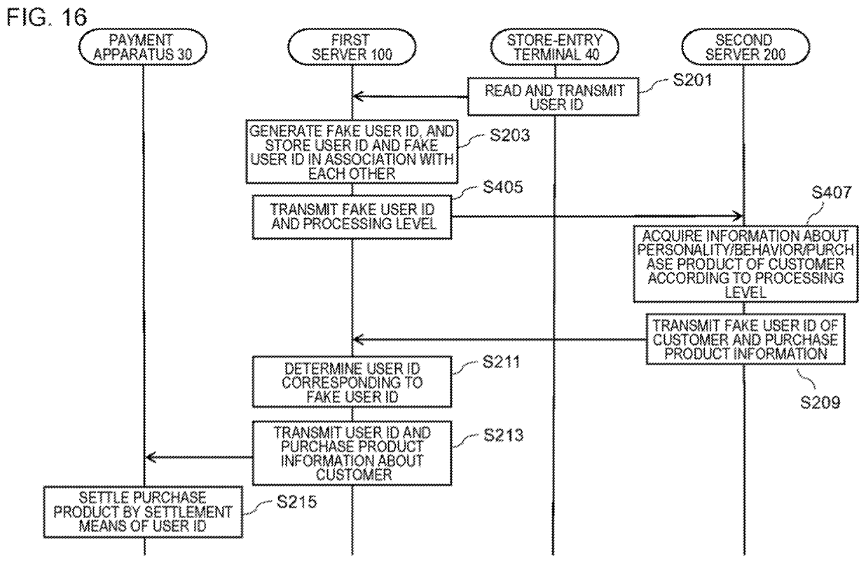

FIG. 16 is a flowchart illustrating an operation example of a store system 1 according to the present example embodiment.

The flow in FIG. 16 includes the same step S201, step S203, and step S209 to step S215 as those in the flow in FIG. 10 according to the second example embodiment, and also further includes step S405 and step S407.

First, a store-entry terminal 40 reads a two-dimensional code displayed on a user terminal 50 provided by the customer U, acquires a user ID, and transmits the user ID to the first server 100 (step S201). Then, in the first server 100, a store-entry management unit 102 generates a fake user ID associated with the user ID received from the store-entry terminal 40, and stores, as store-entry management information 142, the user ID and the fake user ID in association with each other in a first storage apparatus 12 (step S203).

Then, the transmission unit 104 refers to the user information 140, acquires a processing level associated with the user ID of the customer U, and transmits the acquired processing level and the generated fake user ID in association with each other to the second server 200 (step S405). The second server 200 detects a store entry of the person (customer U), and acquires person feature information and purchase product information about the person (customer U) in the store 60. At this time, tracking processing of the person (customer U) is performed according to the processing level of the person (customer U) of the fake user ID being received from the first server 100 (step S407). A specific example of the processing of the second server 200 will be described in detail in the fifth example embodiment described below. Hereinafter, processing procedures in step S209 and subsequent steps are similar to those in the second example embodiment.

According to the present example embodiment, a processing level of tracking of a person (customer U) at the store 60 can be changed for each person (customer U), and thus collection of information about the person (customer U) can be appropriately achieved in the second system 20. The processing level of the person (customer U) can be appropriately set, and thus accuracy of an image recognition result in the tracking processing can be improved. Alternatively, image recognition processing with high accuracy can also be prevented from being performed unnecessarily, and thus a load on the tracking processing can also be appropriately suppressed. The present example embodiment can also achieve an effect similar to that in the first example embodiment.

### Fifth Example Embodiment

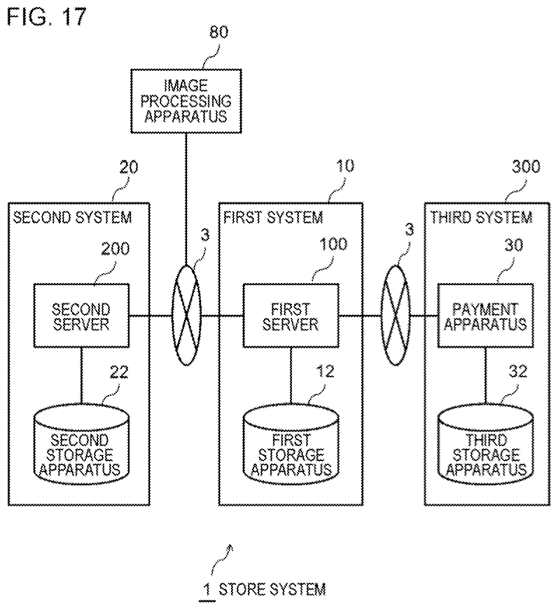

FIG. 17 is a diagram illustrating a configuration example of a store system 1 according to the present example embodiment. The present example embodiment is the same as at least any one of the first example embodiment to the fourth example embodiment described above except for a point that the store system 1 includes a second system 20 in addition to a first system 10. In the present example embodiment, a combination in which the second system 20 is included in the store system 1 according to the first example embodiment will be described, but the present example embodiment can be combined with any other example embodiment within a consistent range.

A second server 200 of the second system 20 associates a fake user ID (second individual determination information) and purchase product information with each other by processing an image in which a store 60 is captured.

### Functional Configuration Example

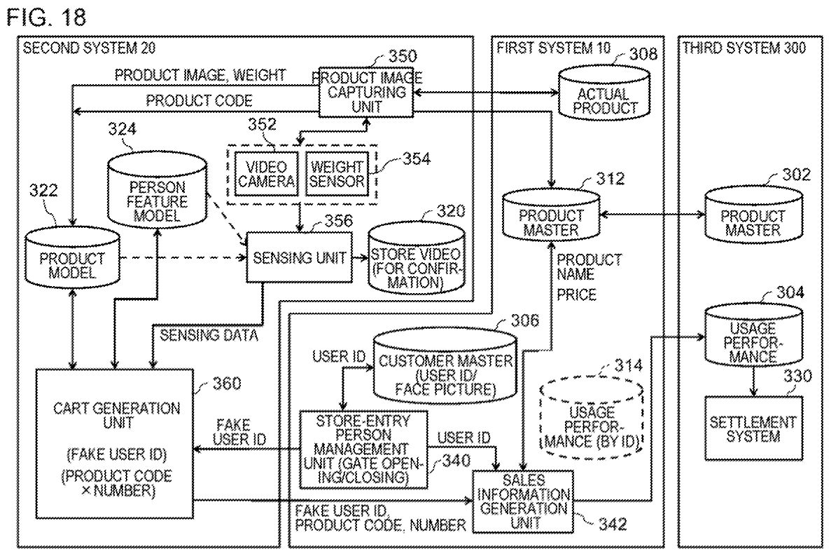

FIG. 18 is a functional block diagram logically illustrating a configuration example of each of the first system 10, the second system 20, and a third system 300 of the store system 1 according to the present example embodiment.

In the present example embodiment, it is assumed that the first system 10, the second system 20, and the third system 300 are systems managed by different organizations. However, at least any two of the first system 10, the second system 20, and the third system 300 may be systems managed by the same organizations.

The first system 10 manages personal information about a customer U and also manages a price of a product 64 by store, and, when the first system 10 receives information about the product 64 put in a cart 66 by the person (customer U) from the second system 20, the first system 10 generates payment information and transmits the payment information to the third system 300.

The second system 20 performs tracking by capturing the person (customer U) who enters the store by a camera 5, determines the product 64 put in the cart 66 by the camera 5 and a weight sensor 7, performs product registration, and passes the registered information to the first system 10.

In the first system 10 and the third system 300, the customer U is managed by a user ID, and, in the second system 20, the person (customer U) is managed by a fake user ID. The second system 20 collects the product 64 purchased by the person (customer U) associated with the fake user ID, person feature information about the person (customer U) in the store 60, and the like.

A first server 100 of the first system 10 includes a store-entry person management unit 340 and a sales information generation unit 342. A first storage apparatus 12 of the first system 10 includes a customer master 306, an actual product information storage unit 308, a product master 312, and a usage performance information storage unit 314.

The second system 20 includes a video camera 352 and a weight sensor 354. The second server 200 of the second system 20 includes a product image capturing unit 350, a sensing unit 356, and a cart generation unit 360. A second storage apparatus 22 of the second system 20 includes a store video storage unit 320, a product model 322, and a person feature model 324.

The third system 300 includes a settlement system 330. A third storage apparatus 32 of the third system 300 includes a product master 302 and a usage performance information storage unit 304.

In the first system 10, the store-entry person management unit 340 corresponds to the store-entry management unit 102 and the transmission unit 104 of the first server 100 in FIG. 4. The sales information generation unit 342 corresponds to the acquisition unit 106 and the output unit 108 of the first server 100 in FIG. 4.

The customer master 306 corresponds to the user information 140 in FIG. 5. The actual product information storage unit 308 stores a product image or a feature value of the product image. The product master 312 corresponds to the store-specific product master 146 in FIG. 12. The usage performance information storage unit 314 corresponds to the purchase information 144 in FIG. 11.

In the second system 20, the video camera 352 corresponds to the camera 5 in FIG. 1. The weight sensor 354 corresponds to the weight sensor 7 in FIG. 1.

In the actual product information storage unit 308, information about a weight of the product 64 is associated with a product image. The product master 312 stores various pieces of information about the product 64. For example, the product master 312 stores information such as a product name, a product code, a price, and a weight of the product 64.

The product image capturing unit 350 acquires an image of a display shelf 62 in the store 60 being generated by the video camera 352, and also acquires a detection result of the weight sensor 354. Then, the product image capturing unit 350 extracts, from the image generated by the video camera 352, a product image that coincides with a product image being registered in the actual product information storage unit 308. Then, the product image capturing unit 350 refers to the product master 312, and determines a product code of the product 64 displayed on the display shelf 62 from the extracted product image. The product image capturing unit 350 further determines a weight of the product 64 associated with the product image from a detection result of the weight sensor 354.

The product image capturing unit 350 registers, in the product model 322, information about the product 64 such as the product image, the weight, and the product code in association. The information registered in the product model 322 is used for determining the product 64 taken out from the display shelf 62 by the person (customer U) by the cart generation unit 360 described below.

The sensing unit 356 acquires an image generated by the video camera 352, and records the image in the store video storage unit 320. Furthermore, the sensing unit 356 acquires a detection result of the weight sensor 354. The sensing unit 356 outputs sensing data including the acquired image and the acquired detection result of the weight sensor 354 to the cart generation unit 360.

The person feature model 324 stores person feature information that is related to behavior and the like of a person and indicates a feature of a person. For example, a “figure” of a person, such as a stature, a gait, a pose, a physiognomy, an expression, gender, age, clothing, and the like, or “behavior” of a person such as a pattern of a movement path, a gesture, action, and the like is registered. However, the person feature information indicating a feature of a person does not include information that can determine an individual.

When the cart generation unit 360 receives a fake user ID of a store-entry person from the first system 10, the cart generation unit 360 starts tracking of the store-entry person by using the sensing unit 356. The cart generation unit 360 refers to the product model 322 and the person feature model 324, and determines a product code and quantity of the product 64 taken out from the display shelf 62 and put in the cart 66 by the store-entry person.

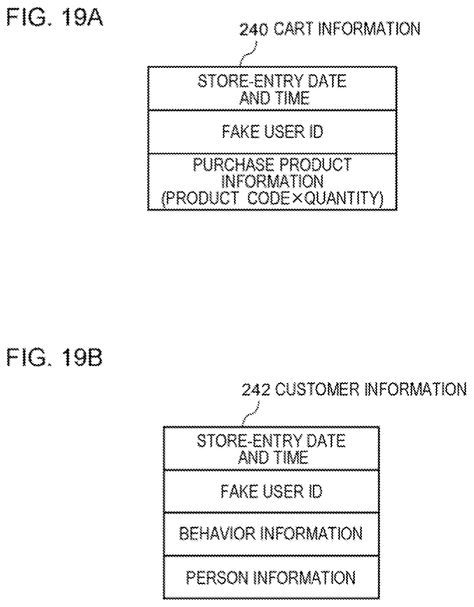

FIG. 19(a) is a diagram illustrating one example of a data structure of cart information 240. In the cart information 240, a store-entry date and time, a fake user ID, and purchase product information (set of a product code and quantity) are stored in association with one another. Furthermore, the cart generation unit 360 refers to the person feature model 324, determines person feature information about a store-entry person, and stores the person feature information in customer information 242 in FIG. 19(b).

In the first system 10, the sales information generation unit 342 acquires product purchase information about the person (customer U) of the fake user ID from the second system 20 after the customer U exits the store. In other words, the sales information generation unit 342 acquires set data of the product code and the quantity as information about the product 64 put in the cart 66 by the person (customer U). Then, a user ID associated with the acquired fake user ID is determined, and payment information about the customer U of the determined user ID is generated based on the acquired product information. The payment information generated by the sales information generation unit 342 may be stored in the usage performance information storage unit 314.

Then, the sales information generation unit 342 transmits the payment information about the customer U to the third system 300.

In the third system 300, the product master 302 stores various pieces of information about the product 64. For example, the product master 302 stores information such as a product name, a product code, a price, and a weight of the product 64. The usage performance information storage unit 304 stores and accumulates, in association with the user ID, the payment information about the customer U being transmitted from the first system 10. The settlement system 330 corresponds to the payment apparatus 30 described above. The settlement system 330 performs settlement of the product 64 being a purchase target of the customer U, based on the payment information about the customer U (user ID).

### Operation Example

Hereinafter, an operation of the store system 1 according to the present example embodiment will be described by using the flowchart in FIG. 10 used in the first example embodiment. Description is given by replacing the payment apparatus 30 in FIG. 10 with the third system 300.

First, a store-entry terminal 40 reads a two-dimensional code displayed on a user terminal 50 provided by the customer U, acquires a user ID, and transmits the user ID to the first server 100 (step S201). Then, in the first server 100, the store-entry person management unit 340 generates a fake user ID associated with the user ID received from the store-entry terminal 40, and stores, as the store-entry management information 142, the user ID and the fake user ID in association with each other in the first storage apparatus 12 (step S203).

Then, the store-entry person management unit 340 transmits the generated fake user ID to the second server 200 (step S205). When the cart generation unit 360 of the second server 200 receives the fake user ID from the first server 100, a store entry is detected by the sensing unit 356 and associated with a person being a tracking target. A method (timing and the like) for associating a person in a store with a fake user ID is not particularly limited, and can be appropriately determined according to a condition (for example, a structure of an entrance (gate), a store-entry method, a detection timing and a sensing content of the sensing unit 356, and the like) for each store. The cart generation unit 360 starts tracking of the person by using the sensing data detected by the sensing unit 356. Then, the cart generation unit 360 refers to the product model 322 and the person feature model 324, and determines person feature information and purchase product information about the person in the store 60 (step S207). The determined information may be recorded in association with the fake user ID.

Specifically, the cart generation unit 360 analyzes and determines behavior of the person in the store 60. Furthermore, the cart generation unit 360 determines a product code and quantity of the product 64 taken out from the display shelf 62 and put in the cart 66 by the person.

Then, in the first server 100, the sales information generation unit 342 receives the fake user ID of the person and the purchase product information (the product code and the quantity) being transmitted from the second server 200 (step S209). The sales information generation unit 342 refers to the store-entry management information 142, and determines the user ID associated with the received fake user ID (step S211).

The sales information generation unit 342 may store, in the usage performance information storage unit 314, the purchase product information (the product code and the quantity) in association with the determined user ID.

Then, the sales information generation unit 342 transmits, to the settlement system 330 of the third system 300, the user ID and the purchase product information (the product code and the quantity) about the customer U being received in step S209 (step S213). At this time, the sales information generation unit 342 also causes the settlement system 330 to perform settlement related to the product 64 being a purchase target of the customer U by using a settlement means associated with the user ID by referring to the user information 140 (step S215).

The present example embodiment can achieve an effect similar to that in the first example embodiment.

While the example embodiments of the present invention have been described with reference to the drawings, the example embodiments are only exemplification of the present invention, and various configurations other than the above-described example embodiments can also be employed.

For example, in the example embodiment described above, purchase product information about the product 64 put in a cart by a person (customer U) is determined based on an image generated by the camera 5 and a detection result of the weight sensor 7. However, in the other example embodiment, an IC tag using radio frequency identification (RFID) may be attached to the product 64, and purchase product information (set of a product code and quantity) of a person (customer U) may be acquired by reading the IC tag at the store-exit gate 72.

Furthermore, in the other example embodiment, the third system 300 in the fifth example embodiment described above may be the payment apparatus 30 of the store 60. As described above, purchase product information is transmitted for each customer U by the output unit 108 from the first server 100 to the payment apparatus 30. The payment apparatus 30 receives the purchase product information about the customer U being received from the first server 100. Then, the received purchase product information is stored in association with a user ID of the customer U in the third storage apparatus 32.

In this configuration example, product registration processing is completed only by putting the product 64 being a purchase target in the cart 66 by the customer U, and the payment information is transmitted to the payment apparatus 30. In other words, this is a configuration in which the payment apparatus 30 is installed at the store 60 and a product registration apparatus is unnecessary.

After the customer U puts the purchase product 64 in the cart 66 at the store 60 and then goes to the payment apparatus 30, the payment apparatus 30 determines the customer U and reads purchase product information (that is, payment information) associated with a user ID of the customer U from the third storage apparatus 32. Then, the payment apparatus 30 performs payment processing, based on the acquired payment information. Herein, various methods for determining the customer U are conceivable and exemplified below, which are not limited thereto.

### (f1) A User ID of the Customer U is Acquired.

For example, similarly to the store-entry terminal 40, a two-dimensional code displayed on the user terminal 50 of the customer U is read by using a code reader, and the user ID of the customer U is acquired.

### (f2) Face (Biometric) Authentication of the Customer U is Performed.

A face image is generated by capturing a face of the customer U by a camera instead of a user ID, and the user ID of the customer U is determined by verifying the face image with a face image of the user information 140.

(f3) a Person (Customer U) is Tracked from a Store Entry to a Store Exit.

Tracking of the person (customer U) is continuously performed by using the camera 5 from a time of a store entry to a time of a store exit, and the person (customer U) operating the payment apparatus 30 is determined.

The invention of the present application is described above with reference to the example embodiments and the examples, but the invention of the present application is not limited to the example embodiments and the examples described above. Various modifications that can be understood by those skilled in the art can be made to the configuration and the details of the invention of the present application within the scope of the invention of the present application.

Note that, when information about a user is acquired and used in the present invention, this is lawfully performed.

A part or the whole of the above-described example embodiment may also be described in supplementary notes below, which is not limited thereto.

1. An information processing apparatus, including:

a store-entry management unit that, when acquiring first individual determination information about a customer who enters a store, generates second individual determination information for a second system separated from a first system for managing customer information, and stores the acquired first individual determination information and the generated second individual determination information in association with each other in a storage unit;

a transmission unit that transmits the second individual determination information to the second system;

an acquisition unit that acquires, from the second system, the second individual determination information and purchase product information being information about a product to be purchased by the customer; and

an output unit that determines the first individual determination information associated with the acquired second individual determination information, and outputs the first individual determination information and the purchase product information to a payment unit.

2. The information processing apparatus according to supplementary note 1, wherein

the payment unit performs settlement related to a product being a target of the purchase by using a settlement means associated with the first individual determination information.

3. The information processing apparatus according to supplementary note 1 or 2, wherein

the second system is provided for each store,

the store-entry management unit acquires the first individual determination information together with store determination information, and stores the acquired store determination information further in association with the second individual determination information, and

the output unit further transmits the store determination information to the payment unit.

4. The information processing apparatus according to any one of supplementary notes 1 to 3, wherein

the first individual determination information is associated with processing level information indicating a processing level needed for tracking the individual, and

the transmission unit further transmits the processing level information to the second system.

5. The information processing apparatus according to any one of supplementary notes 1 to 4, wherein

the store-entry management unit acquires the first individual determination information from a terminal located at an entrance of the store.

6. An information processing method, including,

by an information processing apparatus:

when acquiring first individual determination information about a customer who enters a store, generating second individual determination information for a second system separated from a first system for managing customer information, and storing the acquired first individual determination information and the generated second individual determination information in association with each other in a storage unit;

transmitting the second individual determination information to the second system;

acquiring, from the second system, the second individual determination information and purchase product information being information about a product to be purchased by the customer; and

determining the first individual determination information associated with the acquired second individual determination information, and outputting the first individual determination information and the purchase product information to a payment unit.

7. The information processing method according to supplementary note 6, wherein

the payment unit performs settlement related to a product being a target of the purchase by using a settlement means associated with the first individual determination information.

8. The information processing method according to supplementary note 6 or 7, wherein

the second system is provided for each store,

the information processing method further including,

by the information processing apparatus:

acquiring the first individual determination information together with store determination information, and storing the acquired store determination information further in association with the second individual determination information; and

further transmitting the store determination information to the payment unit.

9. The information processing method according to any one of supplementary notes 6 to 8, wherein

the first individual determination information is associated with processing level information indicating a processing level needed for tracking the individual,

the information processing method further including,

by the information processing apparatus,

further transmitting the processing level information to the second system.

10. The information processing method according to any one of supplementary notes 6 to 9, further including,

by the information processing apparatus,

acquiring the first individual determination information from a terminal located at an entrance of the store.

11. A program for causing a computer to execute:

a procedure of, when acquiring first individual determination information about a customer who enters a store, generating second individual determination information for a second system separated from a first system for managing customer information, and storing the acquired first individual determination information and the generated second individual determination information in association with each other in a storage unit;

a procedure of transmitting the second individual determination information to the second system;

a procedure of acquiring, from the second system, the second individual determination information and purchase product information being information about a product to be purchased by the customer; and

a procedure of determining the first individual determination information associated with the acquired second individual determination information, and outputting the first individual determination information and the purchase product information to a payment unit.

12. The program according to supplementary note 11, wherein

the payment unit performs settlement related to a product being a target of the purchase by using a settlement means associated with the first individual determination information.

13. The program according to supplementary note 11 or 12, wherein

the second system is provided for each store, and

the program further causes a computer to execute:

a procedure of acquiring the first individual determination information together with store determination information, and storing the acquired store determination information further in association with the second individual determination information; and

a procedure of further transmitting the store determination information to the payment unit.

14. The program according to any one of supplementary notes 11 to 13, wherein

the first individual determination information is associated with processing level information indicating a processing level needed for tracking the individual, and

the program further causes a computer to execute

a procedure of further transmitting the processing level information to the second system.

15. The program according to any one of supplementary notes 11 to 14, further causing a computer to execute:

a procedure of acquiring the first individual determination information from a terminal located at an entrance of the store.

16. A store system, including:

a first apparatus that manages personal information; and

a second apparatus that associates a customer and a product in a store with each other, wherein

the first apparatus includes
a store-entry management unit that, when acquiring first individual determination information about a customer who enters a store, generates second individual determination information for the second apparatus, and stores the acquired first individual determination information and the generated second individual determination information in association with each other in a storage unit,
a transmission unit that transmits the second individual determination information to the second apparatus,
an acquisition unit that acquires, from the second apparatus, the second individual determination information and purchase product information being information about a product to be purchased by the customer, and
an output unit that determines the first individual determination information associated with the acquired second individual determination information, and outputs the first individual determination information and the purchase product information to a payment unit, and
   the second apparatus associates the second individual determination information and the purchase product information with each other by processing an image in which the store is captured.
      17. The store system according to supplementary note 16, wherein

the payment unit performs settlement related to a product being a target of the purchase by using a settlement means associated with the first individual determination information.

18. The store system according to supplementary note 16 or 17, wherein

the second apparatus is provided for each store,

in the first apparatus,

the store-entry management unit acquires the first individual determination information together with store determination information, and stores the acquired store determination information further in association with the second individual determination information, and

the output unit further transmits the store determination information to the payment unit.

19. The store system according to any one of supplementary notes 16 to 18, wherein

the first individual determination information is associated with processing level information indicating a processing level needed for tracking the individual, and

the transmission unit of the first apparatus further transmits the processing level information to the second apparatus.

20. The store system according to any one of supplementary notes 16 to 19, wherein

the store-entry management unit of the first apparatus acquires the first individual determination information from a terminal located at an entrance of the store.

This application is based upon and claims the benefit of priority from Japanese patent application No. 2020-083888, filed on May 12, 2020, the disclosure of which is incorporated herein in its entirety by reference.

### REFERENCE SIGNS LIST

1 Store system
3 Communication network
5 Camera
7 Weight sensor
10 First system
10 Gate apparatus
12 First storage apparatus
20 Second system
22 Second storage apparatus
30 Payment apparatus
32 Third storage apparatus
40 Store-entry terminal
50 User terminal
60 Store
62 Display shelf
64 Product
66 Cart
70 Store-entry gate
72 Store-exit gate
100 First server
102 Store-entry management unit
104 Transmission unit
106 Acquisition unit
108 Output unit
120 Payment processing unit
140 User information
142 Store-entry management information
144 Purchase information
146 Store-specific product master
200 Second server
240 Cart information
242 Customer information
300 Third system
302 Product master
304 Usage performance information storage unit
306 Customer master
308 Actual product information storage unit
312 Product master
314 Usage performance information storage unit
320 Store video storage unit
322 Product model
324 Person feature model
330 Settlement system
340 Store-entry person management unit
342 Sales information generation unit
350 Product image capturing unit
352 Video camera
354 Weight sensor
356 Sensing unit
360 Cart generation unit
1000 Computer
1010 Bus
1020 Processor
1030 Memory
1040 Storage device
1050 Input/output interface
1060 Network interface

What is claimed is:

1. An information processing apparatus, comprising:
at least one memory configured to store instructions; and
at least one processor configured to execute the instructions to:
when acquiring first individual determination information about a customer who enters a store, generate second individual determination information for a second system separated from a first system for managing customer information, and store the acquired first individual determination information and the generated second individual determination information in association with each other in a storage unit;
transmit the second individual determination information to the second system;
acquire, from the second system, the second individual determination information and purchase product information being information about a product to be purchased by the customer; and
determine the first individual determination information associated with the acquired second individual determination information, and output the first individual determination information and the purchase product information to a payment unit.

2. The information processing apparatus according to claim 1, wherein
the payment unit performs settlement related to a product being a target of the purchase by using settlement means associated with the first individual determination information.

3. The information processing apparatus according to claim 1, wherein
the second system is provided for each store,
the at least one processor is further configured to execute the instructions to:
acquire the first individual determination information together with store determination information, and store the acquired store determination information further in association with the second individual determination information, and
transmit the store determination information to the payment unit.

4. The information processing apparatus according to claim 1, wherein
the first individual determination information is associated with processing level information indicating a processing level needed for tracking the individual, and
the at least one processor is further configured to execute the instructions to further transmit the processing level information to the second system.

5. The information processing apparatus according to claim 1, wherein the at least one processor is further configured to execute the instructions to acquire the first individual determination information from a terminal located at an entrance of the store.

6. An information processing method, comprising,
by an information processing apparatus:
when acquiring first individual determination information about a customer who enters a store, generating second individual determination information for a second system separated from a first system for managing customer information, and storing the acquired first individual determination information and the generated second individual determination information in association with each other in a storage unit;
transmitting the second individual determination information to the second system;
acquiring, from the second system, the second individual determination information and purchase product information being information about a product to be purchased by the customer; and
determining the first individual determination information associated with the acquired second individual determination information, and outputting the first individual determination information and the purchase product information to a payment unit.

7. The information processing method according to claim 6, wherein
the payment unit performs settlement related to a product being a target of the purchase by using settlement means associated with the first individual determination information.

8. The information processing method according to claim 6, wherein
the second system is provided for each store,
the information processing method further comprising,
by the information processing apparatus:
acquiring the first individual determination information together with store determination information, and storing the acquired store determination information further in association with the second individual determination information; and
further transmitting the store determination information to the payment unit.

9. The information processing method according to claim 6, wherein
the first individual determination information is associated with processing level information indicating a processing level needed for tracking the individual,
the information processing method further comprising,
by the information processing apparatus,
further transmitting the processing level information to the second system.

10. The information processing method according to claim 6, further comprising,
by the information processing apparatus,
acquiring the first individual determination information from a terminal located at an entrance of the store.

11-15. (canceled)

16. A store system, comprising:
a first apparatus that manages personal information; and
a second apparatus that associates a customer and a product in a store with each other, wherein
the first apparatus includes
at least one memory configured to store instructions; and
at least one processor configured to execute the instructions to:
when acquiring first individual determination information about a customer who enters a store, generate second individual determination information for the second apparatus, and store the acquired first individual determination information and the generated second individual determination information in association with each other in a storage unit,
transmit the second individual determination information to the second apparatus,
acquire, from the second apparatus, the second individual determination information and purchase product information being information about a product to be purchased by the customer, and
determine the first individual determination information associated with the acquired second individual determination information, and output the first individual determination information and the purchase product information to a payment unit, and
the second apparatus associates the second individual determination information and the purchase product information with each other by processing an image in which the store is captured.

17. The store system according to claim 16, wherein
the payment unit performs settlement related to a product being a target of the purchase by using settlement means associated with the first individual determination information.

18. The store system according to claim 16, wherein
the second apparatus is provided for each store,
in the first apparatus, the at least one processor is further configured to execute the instructions to:
acquire the first individual determination information together with store determination information, and store the acquired store determination information further in association with the second individual determination information, and
transmit the store determination information to the payment unit.

19. The store system according to claim 16, wherein
the first individual determination information is associated with processing level information indicating a processing level needed for tracking the individual, and
the at least one processor of the first apparatus is further configured to execute the instructions to further transmit the processing level information to the second apparatus.

20. The store system according to claim 16, wherein
the at least one processor of the first apparatus is further configured to execute the instructions to acquire the first individual determination information from a terminal located at an entrance of the store.
